(19) United States
(12) Patent Application Publication
(10) Pub. No.: US 2025/0081303 A1
(43) Pub. Date: Mar. 6, 2025

(54) LIGHT-EMITTING DEVICE FOR A MOTOR VEHICLE

(71) Applicant: VALEO VISION, Bobigny (FR)

(72) Inventors: Sebastian KRICK, Bobigny (FR); Hafid EL IDRISSI, Bobigny (FR)

(73) Assignee: VALEO VISION, Bobigny (FR)

(21) Appl. No.: 18/721,943

(22) PCT Filed: Dec. 26, 2022
(86) PCT No.: PCT/EP2022/087849

§ 371 Date: Jun. 20, 2024

(30) Foreign Application Priority Data
Dec. 26, 2021 (FR) 2114525

(51) Int. Cl. H05B 45/14; F21S 41/153; F21S 41/663; H05B 45/18; H05B 45/34

(52) U.S. Cl. CPC H05B 45/14; F21S 41/153; F21S 41/663; H05B 45/18; H05B 45/34

(57) ABSTRACT

The invention proposes a luminous device involving a converter intended to supply power to a pixelated light source controlled by electric current. The device makes it possible to reduce power losses and to reduce the risk of the elementary light sources of the pixelated light source overheating. By using a control loop and measuring means which make it possible to directly or indirectly measure a value which is indicative of the voltage drop at the terminals of at least one current source of the pixelated light source, it becomes possible to dynamically adapt the voltage delivered by the converter circuit.

### TECHNICAL FIELD

The invention relates to the field of luminous systems of automotive vehicles, and in particular it relates to such systems using pixelated light sources controlled by electric current.

### BACKGROUND OF THE INVENTION

A light-emitting diode (LED) is a semiconductor electronic component which is capable of emitting light of a predetermined wavelength when a voltage which is at least equal to a threshold value is applied to its terminals. Beyond this threshold value, which is called the forward voltage, the intensity of the luminous flux emitted by an LED increases, in general, in proportion to the average intensity of the supply current. Their small size and their low electricity consumption make LED components advantageous in the field of luminous modules for automotive vehicles. LED light sources may, for example, be used to produce distinctive optical signatures by placing the components along predetermined outlines. By using LED components, producing lights with multiple luminous functions is also made easier.

It is also known practice to use pixelated light sources from various types of technologies to project these light beams on the basis of image data. It is a case, for example, of monolithic technology, in which a large number of light-emitting diode (LED) elementary sources, which are equivalent to pixels, are etched into a common semiconductor substrate. The substrate may further comprise embedded electronic components, such as switching circuits or others. During control by electric current, the intensity of the electric current which passes through a given elementary source is adjusted by a current source which is associated with it: thus the luminous intensity emitted by each of the pixels may be adapted in order to project image data.

Pixelated light sources may be used to perform “high beam” (HB) functions, or complex functions such as ADB (Adaptive Driving Beam) or others. The corresponding images, or photometries, may have very different degrees of luminosity and of luminous homogeneity. When the whole array emits light, the electric current draw of the pixelated source is very large, whereas for a low beam (LB) function, for example, around half of the pixels remain dark, therefore the electric current draw is divided by two.

In a known manner, a converter circuit which takes part in supplying electric power to such pixelated light sources controlled by current is configured statically in order to deliver a voltage of a constant value, which makes it possible for the pixelated light source to operate at a maximum drawn electric current (i.e., combined for all the elementary sources). The level of this voltage must also be sufficiently high for the voltage delivered to the pixelated light source to be at an appropriate level even after having suffered a voltage drop due to the impedance represented by a connection harness of maximum length between the converter and the pixelated light source. This causes the problem that, in all cases which need a smaller current draw, for example during LB operation, or in all cases where a connection harness having a shorter length and therefore a smaller impedance, involving a smaller voltage drop, the constant voltage delivered by the converter circuit will be oversized and too high with respect to the real needs of the system. This leads to an electric power loss in the current sources, which dissipate the excess power in the form of heat. However, the semiconductor elementary sources of dimensions which are very fine and very close to the current sources in question are very sensitive to overheating, and may be irreversibly damaged in the event of excessive heat.

### SUMMARY OF THE INVENTION

The objective of the invention is to mitigate at least one of the problems posed by the prior art. More specifically, the objective of the invention is to propose a luminous device involving a converter intended to supply power to a pixelated light source controlled by electric current, which makes it possible to reduce power losses and to reduce the risk of the elementary light sources of the pixelated light source overheating.

According to a first aspect of the invention, a luminous device for an automotive vehicle is proposed. The device comprises a pixelated light source intended to be controlled by current, the pixelated light source comprising a plurality of light-emitting semiconductor elements and a plurality of electric current sources, each electric current source being associated with one of the light-emitting semiconductor elements. The device also comprises a controlled converter circuit, connected to the pixelated light source in order to supply it with electricity. The device further comprises control means which connect the pixelated light source to a control input of the converter circuit, which are configured to deliver a control signal which is representative of a voltage drop at the terminals of at least one of the electric current sources.

Preferably, the converter circuit may be configured to deliver, on the basis of said control signal, a voltage the value of which is such that, after voltage drops due to the connections between the converter circuit and the pixelated light source have been subtracted, and after the forward voltage of the at least one light-emitting semiconductor element associated with the at least one electric current source involved in the control means has been subtracted, the voltage drop at the terminals thereof lies in a predetermined range of values.

The control means may preferably comprise measuring means.

The measuring means may preferably comprise a comparator element configured to measure a voltage drop at the terminals of at least one of the electric current sources.

Preferably, the measuring means may comprise a comparator element configured to measure the voltage delivered to the pixelated light source, and at least one temperature sensor associated with a plurality of light-emitting semiconductor elements, as well as a memory element comprising data which establish a relationship between a temperature and a current which are measured, on the one hand, and a forward voltage, on the other hand.

Preferably, the control means may comprise a circuit configured to generate the control signal which is representative of the voltage drop at the terminals of at least one of the electric current sources on the basis of the quantities measured by the measuring means.

The control means may preferably be connected to the converter circuit by means of a data bus of the automotive vehicle. It may preferably be a case of a CAN (car area network) data bus. Employing a communication bus makes it possible to deliver a control signal over any distances without harm (static, electromagnetic interference) to the value received at the control input.

Preferably, the control means may be configured to sequentially deliver a control signal which is representative of a voltage drop at the terminals of various electric current sources. Employing a communication bus is particularly suitable for carrying out this transmission.

The predetermined range of values may preferably have a span of at most 0.5 V and comprises a lower bound which is substantially equal to a headroom value of the at least one electric current source.

Preferably, the pixelated light source may comprise a monolithic pixel array, each pixel corresponding to a light-emitting semiconductor element.

The electrical connections which connect the converter circuit to the pixelated light source may preferably comprise resistive elements inducing non-negligible voltage drops between the converter circuit and the pixelated light source.

Preferably, the converter circuit may comprise a voltage step-down circuit, a voltage step-up circuit, or a combination of these two types of circuits.

By using the measures proposed by the present invention, it becomes possible to propose a luminous device involving a converter intended to supply power to a pixelated light source controlled by electric current, which makes it possible to reduce power losses and to reduce the risk of the elementary light sources of the pixelated light source overheating. By using a control loop and measuring means which make it possible to directly or indirectly measure a value which is indicative of the voltage drop at the terminals of at least one current source of the pixelated light source, it becomes possible to dynamically adapt the voltage delivered by the converter circuit. The regulation is such that a headroom voltage at the terminals of the electric current source is maintained, without it becoming too high, which would involve a power loss and the light source overheating. The regulation is independent of the connection impedances and lengths between the converter circuit and the pixelated light source, and adapts to current draws which vary in accordance with the photometries projected by the luminous device.

### BRIEF DESCRIPTION OF DRAWINGS

Other features and advantages of the present invention will be better understood from the description of the examples and of the drawings, in which:

FIG. 1 is a schematic illustration of a luminous device according to one preferred embodiment of the invention;

FIG. 2 is a schematic illustration of a luminous device according to one preferred embodiment of the invention; and

FIG. 3 is a schematic illustration of a luminous device according to one preferred embodiment of the invention.

### DETAILED DESCRIPTION OF THE INVENTION

Unless specified otherwise, technical features described in detail for one given embodiment may be combined with the technical features described in the context of other embodiments described by way of examples and non-limitingly.

The description concentrates on the elements of a luminous device for an automotive vehicle, which are necessary for understanding the invention. Other elements, which in a known manner form part of such devices, will not be mentioned or described in detail. For example, the presence of a carrier or of heat-dissipating elements are implicit for the operation of such a device.

FIG. 1 shows a luminous device 100 for an automotive vehicle according to a first embodiment. The device comprises a converter circuit 120. Voltage step-down, for example buck, converter circuits and voltage step-up, for example boost, converter circuits are in themselves known from the art and their operation will not be described in detail in the context of the present invention. The invention is not limited to a specific converter architecture. A converter circuit 120 notably makes it possible to convert a voltage delivered to its input (not illustrated) into an output voltage Vout having a value which is different from the input voltage. According to the chosen architecture, the output voltage may be higher or lower than the input voltage. Such circuits are commonly used in the context of supplying electric power to light sources with light-emitting semiconductor components, such as light-emitting diodes (LEDs), for example. Specifically, such light sources must be supplied with a voltage level which is at least equal to the value of their forward voltage, which may be different from the available voltage, which is, for example, delivered by a battery of an automotive vehicle. The converter notably comprises an additional input 122 intended to receive a control voltage value, so as to be able to regulate the voltage delivered between its supply output terminals. One of the output terminals typically corresponds to the ground potential. The device also comprises a pixelated light source 110 comprising, for example, a monolithic array element. The light source 110 is controlled by current and it is connected by electrical connections to the converter circuit. As these electrical connections represent an impedance which depends notably on their length and their cross-sectional area, the voltage Vled delivered to the light source 110 is lower than the output voltage Vout of the converter circuit.

The pixelated light source 110 comprises a generally large number of light-emitting semiconductor elements, such as light-emitting diodes 112. A dedicated current source 114 is associated with each of these elements 112. A photometry setpoint (not illustrated) delivered to the pixelated light source 110 leads the latter to apply an electric current of an intensity which is appropriate to each pixel produced by an element 112 and an electric current source 114. Thus, each pixel emits a degree of luminosity which conforms to the photometric setpoint. For a given drawn current, the forward voltage Vf at the terminals of the light-emitting diode corresponds to a given value, which is an intrinsic property of the diode. The forward voltage is, in general, dependent on the temperature of the semiconductor junction. In order to operate correctly, the current source 114 needs a constant headroom voltage Vh of a predetermined value, typically of around 0.5 V or, between its terminals. If Vled is much higher than Vf, the residual potential difference Vh is high and causes heat losses.

In the example of FIG. 1, a control loop, produced, for example, by a data connection, connects measuring means which are able to measure a value which is indicative of this potential difference Vh to the converter circuit. By using the control means 130, it therefore becomes possible for the converter circuit to step down Vout when the controlled value 134 indicates a value Vh which is higher than the headroom voltage required by the electric current source 114. When Vh approaches its lower limit value, Vout may be increased. This makes it possible to avoid power losses while at the same time controlling each elementary light source 112 by electric current. The maximum of several voltage drops which are measured at the terminals of several current sources 114 which are associated with several semiconductor elements 112 may also serve as a control value, without, however, departing from the scope of the present invention. Indirectly, this architecture also makes it possible to take into account the voltage drops between the converter circuit 120 and the light source 110.

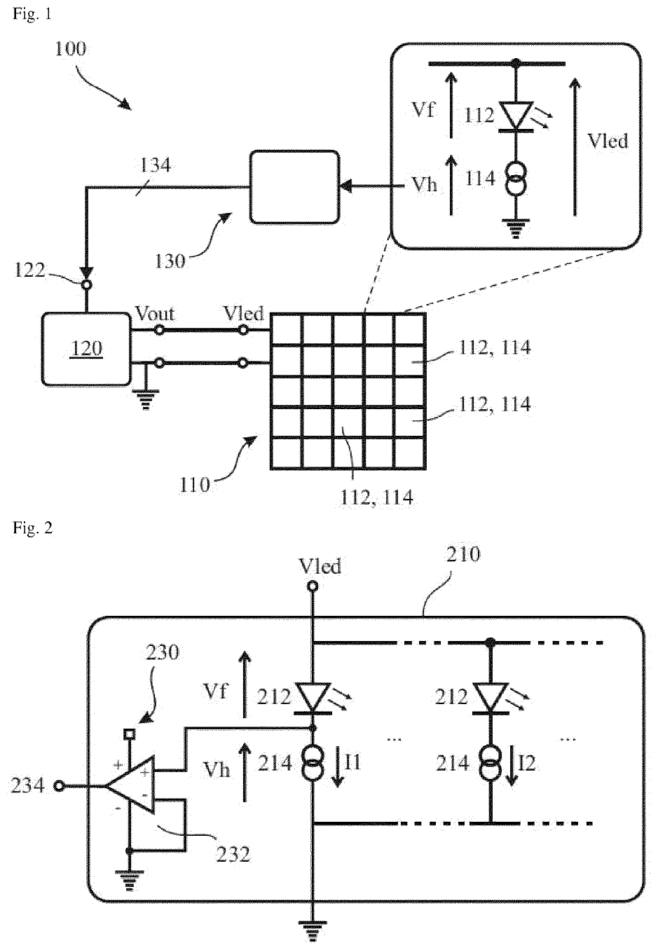

FIG. 2 shows an illustration of a pixelated light source 210 and control means 230 according to a second preferred embodiment. Part of the converter circuit remains unchanged with respect to the preceding embodiment and it is not shown. A plurality of pairs formed by connecting a light-emitting light source 212 in series with its associated electric current source 214 are connected in parallel. The measuring means 232 comprise an analog-to-digital converter circuit referenced to the ground potential, which makes it possible to directly deliver the value 234 of the voltage drop at the terminals of at least one of the electric current sources 214 to the control input of the converter circuit.

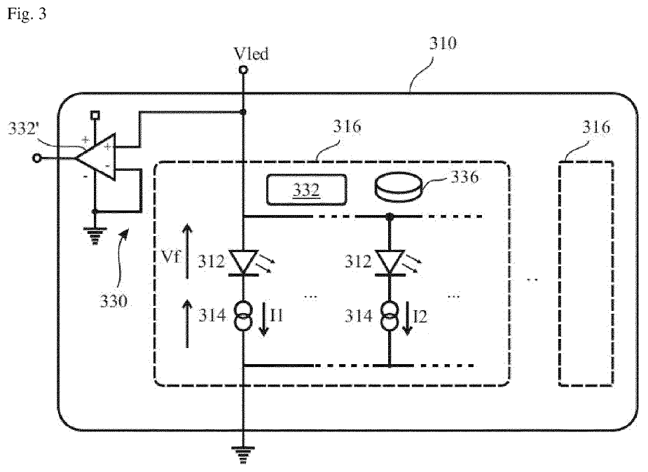

FIG. 3 shows an illustration of a pixelated light source 310 and control means 330 according to a third preferred embodiment. Part of the converter circuit remains unchanged with respect to the preceding embodiments and it is not shown. A plurality of pairs formed by connecting a light-emitting light source 312 in series with its associated electric current source 314 are connected in parallel. Groups 316 of such pairs are heat-coupled because of their physical proximity. The measuring means comprise, at least for each group 316, at least one temperature sensor 332 which makes it possible to deliver an indication of the junction temperature of the light sources 312 of the group in question. The sensor may, for example, be produced by a thermistor, without limiting the invention to this example. Knowing the temperature and the drawn current of a given light-emitting diode 312, it is possible to deduce therefrom the forward voltage Vf at the terminals of the light-emitting diode. To this end, data for calibrating the light-emitting diodes are pre-provided in a memory element 336, for example in tabular form. By measuring the voltage Vled delivered, for example by means of the analog-to-digital converter circuit 332′, a processing circuit which is not illustrated therefore has access to an estimate of the voltages Vled and Vf, which makes it possible to indirectly deduce the voltage drop Vh at the terminals of the electric current source 314. This estimate of Vh is relayed as a control signal to the control input of the converter circuit. Alternatively, the control signal may comprise the estimates of temperature, of the voltage Vled and/or the estimate of Vf. Processing these quantities in the converter circuit, by means of a corresponding processor circuit, then makes it possible to recover the estimate of the voltage drop Vh. Once the estimate of Vh has been acquired, the regulation described in the preceding embodiments may be performed.

In an alternative embodiment which is not illustrated, the pixelated light source comprises a diagnostic circuit which makes it possible for it to individually diagnose the forward voltage value Vf for each elementary light source cyclically or sequentially. When Vf is close to 0 V, the corresponding pixel is diagnosed as being in a short circuit. When Vf is close to Vled, the pixel is open. When the measured forward voltage Vf is in an acceptable and functional range of values, this measurement may be used, as in the preceding embodiment, to deduce therefrom the voltage drop at the terminals of the electric current source which is associated with the diagnosed pixel, by using the relationship Vh=Vled−Vf. This arrangement makes it possible to evaluate Vh for all the elementary light sources sequentially.

Needless to say, the described embodiments do not limit the scope of the protection of the invention. Notably, more complex and more exact measuring methods, involving, for example, a larger number of temperature and/or voltage sensors, may be implemented in order to produce the measuring means which have just been described, without, however, departing from the scope of the present invention. By making use of the description which has just been given, other embodiments may be envisaged without, however, departing from the scope of the present invention.

The scope of the protection is determined by the claims.

What is claimed is:

1. A luminous device for an automotive vehicle comprising
a pixelated light source intended to be controlled by current, the pixelated light source including a plurality of light-emitting semiconductor elements and a plurality of electric current sources, each electric current source being associated with one of the light-emitting semiconductor elements;
a controlled converter circuit, connected to the pixelated light source in order to supply it with electricity;
a controller connected to a control input of the converter circuit, the controller configured to deliver a control signal which is representative of a voltage drop at the terminals of at least one of the electric current sources.

2. The luminous device as claimed in claim 1, wherein the converter circuit is configured to deliver, on the basis of the control signal, a voltage Vout the value of which is such that, after voltage drops due to the connections between the converter circuit and the pixelated light source have been subtracted, and after the forward voltage Vf of the at least one light-emitting semiconductor element associated with the at least one electric current source involved in the controller has been subtracted, the voltage drop at the terminals thereof lies in a predetermined range of values.

3. The luminous device as claimed in claim 1, wherein the controller includes a measuring means.

4. The luminous device as claimed in claim 3, wherein the measuring means includes an analog-to-digital converter element configured to measure a voltage drop at the terminals of at least one of the electric current sources.

5. The luminous device as claimed in claim 3, wherein the measuring means includes an analog-to-digital converter element configured to measure the voltage Vled delivered to the pixelated light source, and at least one temperature sensor associated with a plurality of light-emitting semiconductor elements, as well as a memory element including data which establishes a relationship between a temperature and a current which are measured, on the one hand, and a forward voltage Vf, on the other hand.

6. The luminous device as claimed in claim 3, wherein the controller includes a circuit configured to generate the control signal which is representative of the voltage drop at the terminals of at least one of the electric current sources on the basis of the quantities measured by the measuring means.

7. The luminous device as claimed in claim 1, wherein the controller is connected to the converter circuit by means of a data bus of the automotive vehicle.

8. The luminous device as claimed in claim 1, wherein the controller is configured to sequentially deliver a control signal which is representative of a voltage drop at the terminals of various electric current sources.

9. The luminous device as claimed in claim 2, wherein the predetermined range of values has a span of at most 0.5 V and includes a lower bound which is substantially equal to a headroom value Vh of the at least one electric current source.

10. The luminous device as claimed in claim 1, wherein the pixelated light source includes a monolithic pixel array, each pixel corresponding to a light-emitting semiconductor element.
